(19) United States
(12) Patent Application Publication
(10) Pub. No.: US 2005/0117642 A1
(43) Pub. Date: Jun. 2, 2005

(54) Moving picture coding method, decoding method, data stream, data recording medium and program

(76) Inventors: Kiyofumi Abe, Kadomi-shi (JP); Shinya Kadono, Nishinomiya-shi (JP); Satoshi Kondo, Yawata-shi (JP); Makoto Hagai, Moriguchi-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/500,291

(22) PCT Filed: May 29, 2003
(86) PCT No.: PCT/JP03/06724

(30) Foreign Application Priority Data
Jun. 28, 2002 (JP) 2002-191153

(51) Int. Cl. H04N 7/12

(52) U.S. Cl. 375/240.12; 375/240.15; 375/240.25

(57) ABSTRACT

In the coding method of the present invention, by adding an identification signal for indicating that there is no need to reorder coded pictures in the case where no picture coded by referring to a single or two pictures in the backward direction in display order is included in the sequence data, a restriction on pictures not to refer to any picture except the pictures that are positioned in the temporally forward direction is imposed and pictures are coded in the same order as the display order. Also, in the decoding method, only pictures that are positioned in the temporally forward direction are referred to according to the above-mentioned identification signal and these coded pictures are decoded in the same order as the display order.

### TECHNICAL FIELD

The present invention relates to a moving picture coding method and a moving picture decoding method, especially to a coding method and a decoding method using a B picture on which prediction coding is performed with reference to a plurality of pictures that have already been coded.

### BACKGROUND ART

In moving picture coding in general, the amount of information is compressed by reducing redundancies both in temporal direction and in spacial direction. With this reason, in the inter picture prediction coding whose object is to reduce the temporal redundancies, motions of vectors are detected and motion compensation is performed block by block with reference to forward or backward pictures so as to code the differential values between the obtained prediction image and the present picture.

FIG. 5 is a diagram showing the example of the reference relations between the above-mentioned picture to be coded and the pictures that are referred to by the current picture to be coded.

Intra picture prediction coding is performed on the picture I1 without reference to any reference pictures. Inter picture prediction coding is performed on the picture P10 with reference to the P7 that is positioned in the temporally forward direction. Also, two pictures that are positioned in the temporally forward direction are referred to when coding the picture B6. Two pictures that are positioned in the temporally backward direction are referred to when coding the picture B12. A picture in the temporally forward direction and another picture in the temporally backward direction are referred to when coding the picture B18 so as to perform inter picture prediction coding.

The possibility that a moving picture coding where B pictures are used is performed with reference to pictures in the temporally backward direction produces a need to code the picture having a possibility of being referred to earlier than the current picture.

FIG. 6A shows the order of pictures to be displayed and FIG. 6B shows the order of pictures to be coded.

In the case where there is a B picture such as B63 in FIG. 6A, as the picture P64 that is referred to by the B63 must be coded earlier than B63, these pictures must be reordered, for example, in the order shown in FIG. 6B and then coded. Reordering these pictures and coding B63 after coding P64 that is positioned in the temporally backward direction from B63 causes a delay when starting the transmission of B63.

Likewise, a decoding apparatus decodes a coded stream that is being inputted in this order shown in FIG. 6B in sequence, but in order to display these decoded pictures, there is a need to reorder these decoded pictures so that they are positioned in the order according to the time base shown in FIG. 6A. Decoding P64 that is positioned in the temporally backward direction from B63 so as to display B63 causes a delay when displaying B63.

As a countermeasure of the delay that is accompanied by the above-mentioned reordering in the conventional coding method such as the MPEG 2, a low delay mode is defined. This low delay mode makes it possible to code and decode pictures without reordering these pictures by not using any B pictures that may refer to a picture in the backward direction when coding and decoding pictures as shown in FIG. 7 (For example, refer to non-patent literature 1).

Non-patent literature 1: ISO/IEC 13818-2, Information technology—Generic coding of moving pictures and associated audio information: Video (May 15, 1996) P. 150 D.5 Low delay mode.

However, not to use any B picture might raise a possibility that the coding efficiency deteriorates to a large extent.

Therefore, an object of the present invention is to realize moving picture coding and decoding in which delays are minimized even in the case where B pictures are used.

### DISCLOSURE OF INVENTION

In order to achieve the above-mentioned object, the coding method in the present invention is for coding pictures using an I picture to be coded by intra picture prediction coding and an inter picture prediction picture to be coded by inter picture prediction coding where a picture in the forward direction or in the backward direction in display order from a picture to be coded is referred to, comprising the steps of: receiving an instruction indicating that coding is performed using pictures made of the I picture coded by intra picture prediction coding and the picture coded by prediction coding with reference to only pictures in the forward direction in display order from the picture to be coded; outputting identification signals indicating that no reordering of pictures is necessary upon receiving the instruction; and coding the pictures together with the identification signal in display order without reordering of the pictures.

In this way, coding is performed using B pictures for performing a prediction coding with reference to only pictures that are positioned in the forward direction from the picture to be coded in display order, which makes it possible to code pictures that have been inputted in display order without reordering.

Also, the decoding method in the present invention is for decoding an I picture and an inter picture prediction coding picture, the I picture being coded by intra picture prediction coding and the inter picture prediction coding picture being coded by inter picture prediction coding where a picture in a forward direction or in a backward direction in display order are referred to, comprising steps of: receiving an identification signal indicating whether or not a reordering of pictures is necessary and picture signals; judging whether the identification signal indicates that the reordering of pictures is necessary or the reordering of pictures is unnecessary; and outputting the signals of the pictures by decoding the signals in receiving order in the case where it is judged that the identification signal indicates that the reordering of pictures is unnecessary, and outputting the pictures by decoding the received signals of the pictures and reordering the pictures in display order in the case where it is judged that the identification signal indicates that the reordering of pictures is necessary.

In this way, decoding is performed using B pictures for performing a decoding with reference to only pictures that are positioned in the forward direction from the picture to be decoded in display order, which makes it possible to decode pictures that have been inputted in display order without reordering.

Also, the decoding method, data streams, data recording media and programs have the same actions and effects as the above-mentioned structures.

Also, data streams in the present invention may have one of structures 1, 2 and 3 that will be explained below.

1. A data stream comprising sequence data and an identification signal, the sequence data being coded using a combination of an I picture for an intra picture prediction coding and a picture for a prediction coding with reference to pictures that are positioned in the forward direction from the picture to be coded in display order and the identification signal indicating that no reordering of these pictures that have already been coded is required in decoding these coded pictures.

2. A data stream comprising sequence data and an identification signal, the sequence data being coded using a combination of a B picture for performing a prediction coding with reference to pictures that are positioned in the forward direction from the picture to be coded in display order, an I picture for performing an intra picture prediction coding and a P picture for performing a prediction coding with reference to only one picture that is positioned in the forward direction from the picture to be coded in display order and the identification signal indicating that no reordering of these pictures that have already been coded is required in decoding these coded pictures.

3. A data stream where an identification signal indicating that no reordering of these pictures that have already been coded is required in decoding these coded pictures in the case where coding is performed using a combination of a B picture for performing a prediction coding with reference to pictures that are positioned in the forward direction from the picture to be coded in display order, an I picture for performing an intra picture prediction coding and a P picture for performing a prediction coding with reference to only one picture that is positioned in the forward direction from the picture to be coded in display order or a data stream where reordering of these pictures that have already been coded is required in decoding these coded pictures in the case where coding is performed using only a part of B pictures, these B pictures are for performing a prediction coding with reference to pictures that are positioned in the backward direction from the picture to be coded in display order.

Also, the picture coding method in the present invention may have one of 4 and 5 that will be explained below.

4. A picture coding method comprising an instruction receiving step, an identification signal outputting step and a picture coding step. The instruction receiving step is for receiving an instruction indicating that coding is performed using pictures made of the I picture for performing intra prediction coding and pictures for performing prediction coding with reference to only pictures in the forward direction from the picture to be coded in display order. The identification signal outputting step is for outputting an identification signal indicating that no reordering of pictures is required in response to the instruction. The picture coding step is for coding, in response to the instruction, the B picture, the I picture and the P picture in display order together with the identification signal without reordering these pictures.

5. A picture coding method comprising an instruction receiving step, an identification signal outputting step and a picture coding step. The instruction receiving step is for receiving an instruction indicating that coding is performed with reference to only a B picture for performing prediction coding with reference to only pictures that are positioned in the forward direction from the picture to be coded in display order, an I picture for performing intra prediction coding and a P picture for performing prediction coding with reference to only one picture that is positioned in the forward direction from the picture to be coded in display order. The identification signal outputting step is for outputting an identification signal indicating that no reordering of pictures is required in response to the instruction. The picture coding step is for coding, in response to the instruction, the B picture, the I picture and the P picture in display order together with the identification signal without reordering these pictures.

Also, the picture decoding method in the present invention may have one of structures 6 and 7.

6. A picture decoding, method comprising a signal receiving step, a picture decoding step and a picture outputting step. The signal receiving step is for receiving an identification signal for indicating that no reordering of pictures is required and signals of pictures that have been coded in display order. The picture decoding step is for decoding signals of pictures that have been received together with the identification signal in the receiving order. The picture outputting step is for outputting pictures that have just been decoded in decoding order so as to display these decoded pictures.

7. A picture decoding method comprising a signal receiving step, a judging step and a picture outputting step. The signal receiving step is for receiving an identification signal indicating whether reordering of pictures is required or not. The judging step is for judging whether the identification signal indicates that reordering of pictures is required or the identification signal indicates that no reordering of pictures is required. The picture outputting step is for decoding and outputting the picture signals in a receiving order in the case where the identification signal is the one indicating that no reordering is required and for decoding the received picture signal, reorder these pictures to a display order and output them in the case where the identification signal is the one indicating that reordering is required.

Also, a program recording medium in the present invention may be the one with a program for causing a computer to execute the picture coding method that is explained in the above-mentioned 3 or 4 or the picture decoding method that is explained in the above-mentioned 6 or 7.

Up to this point, the moving picture coding method in the present invention makes it possible to omit the processing for switching the order of the pictures that have been inputted in the coding apparatus and also minimize temporal delays caused by the coding processing. Further, the present invention makes it possible to reduce the amount of the coding processing and reduce the processing amount of the coding apparatus.

Also, the moving picture decoding method in the present invention makes it possible to omit the processing for switching the order of the pictures that have been decoded so as to display these decoded pictures and also minimize temporal delays caused by the decoding processing. Further, the present invention makes it possible to reduce the amount of the decoding processing and reduce the processing amount of the decoding apparatus.

### BRIEF DESCRIPTION OF DRAWINGS

FIG. 1 is a block diagram explaining the coding operation in a first embodiment of the present invention.

FIG. 2 is a block diagram explaining the decoding operation in a second embodiment of the present invention.

FIGS. 3A and 3B are a schematic diagram explaining the method for adding identification signals for restricting prediction direction to header areas.

FIGS. 4A and 4B are a diagram showing the correlation between an identification number for restricting prediction direction and a usable picture.

FIG. 5 is a schematic diagram explaining the reference relations between pictures in the conventional example.

FIG. 6 is a schematic diagram explaining how to order these pictures.

FIG. 7 is a schematic diagram explaining the conventional reference relations in the case where a prediction direction is restricted to the forward direction.

FIG. 8 is a schematic diagram explaining the reference relations in the present invention in the case where a prediction direction is restricted to the forward direction.

FIGS. 9A and 9B are a flow chart explaining the outline of the flow of a coding processing.

FIGS. 10A and 10B are a flow chart explaining the outline of the flow of a decoding processing.

FIG. 11 is a schematic diagram comparing the effects brought by imposing a prediction restriction on pictures.

FIG. 12A to 12D are a diagram showing the procedure for outputting instructions to the coded stream generation unit.

FIG. 13 is a flow chart explaining the outline of the flow of a decoding processing.

FIG. 14A to 14C are a diagram showing the correlation between the identification numbers for restricting prediction direction and the usable pictures.

FIGS. 15A and 15B are a schematic diagram showing a picture common information area where identification signals for restricting prediction directions are set.

FIG. 16A to 16C are a schematic diagram explaining a data recording medium in a fourth embodiment of the present invention.

FIG. 17 shows the whole structure of the contents supply system that realizes a contents distribution service concerning the present invention.

FIG. 18 shows an example of a cellular phone concerning the present invention.

FIG. 19 shows the internal structure of the cellular phone.

FIG. 20 shows the structure of a digital broadcasting system concerning the present invention.

### BEST MODE FOR CARRYING OUT THE INVENTION

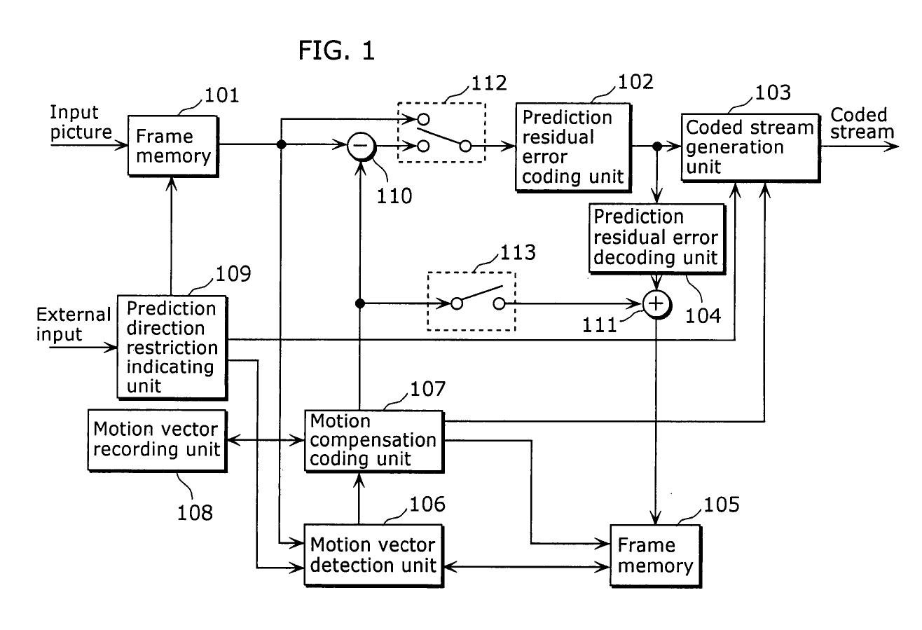

The moving picture coding method in the first embodiment of the present invention will be explained with reference to the block diagram shown in FIG. 1.

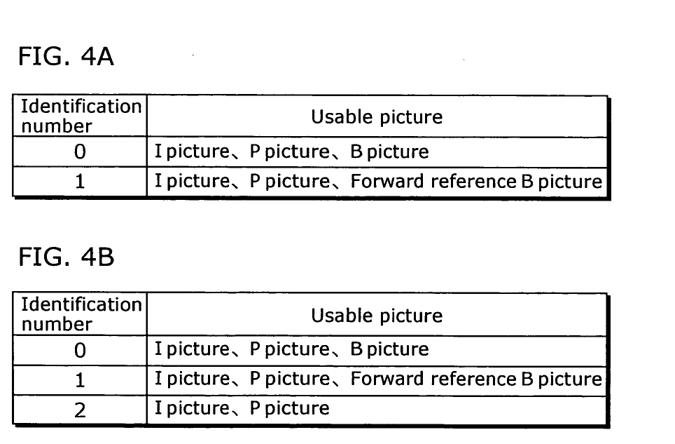

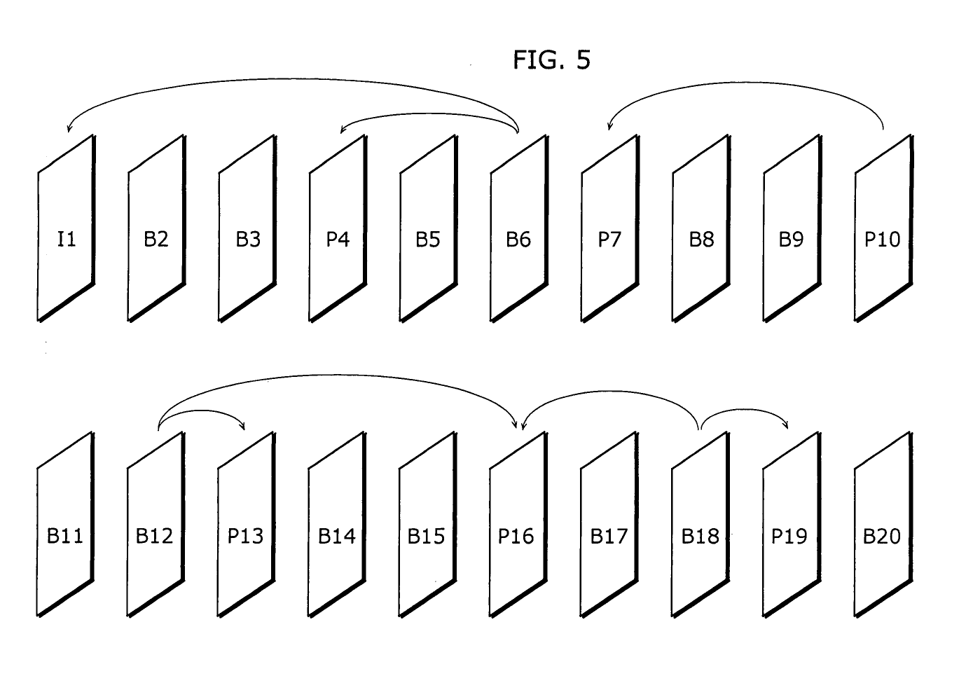

The prediction direction restriction indicating unit 109 receives an instruction from outside and controls the reference method at the time of inter picture prediction. Here are examples of reference methods at the time of using B pictures in the inter picture prediction:
1. referring to two pictures that are positioned in the forward direction shown in, for example, B6 in FIG. 5;
2. referring to two pictures that are positioned in the backward direction shown in, for example, B12 in FIG. 5; and
3. referring to a single picture that is positioned in the forward direction and another picture that is positioned in the backward direction shown in B18 in FIG. 5. Here are examples of prediction modes such as a prediction mode for referring to two pictures in the forward direction, a prediction mode for referring to two pictures in the backward direction and a prediction mode for referring to pictures both in the forward direction and in the backward direction. However, in the case where the prediction direction restriction indicating unit 109 imposes a restriction on pictures not to refer to any picture except the pictures that are positioned in the temporally forward direction, a prediction mode for referring to pictures that are positioned in the temporally backward direction is not selected in coding B pictures. Usable pictures are determined depending on the inputted instruction as shown in, for example, FIG. 4A and FIG. 4B. In order to simplify the explanation, identification numbers shown in FIGS. 4A and 4B are inputted as instructions below. The inputted instructions (identification numbers) are outputted to the frame memory 101, the coded stream generating unit 103 and the motion vector detecting unit 106 from the prediction direction restriction indicating unit 109.

The moving pictures to be coded are inputted in the frame memory 101 in display order picture by picture. In the case where the prediction direction restriction indicating unit 109 does not impose any restriction on pictures, these pictures are reordered in coding order in the frame memory 101. Also, in the case where the prediction direction restriction indicating unit 109 imposes a restriction on pictures not to refer to any picture except the pictures that are positioned in the temporally forward direction, no ordering of pictures is performed. Here, the case where only the pictures that are positioned in the temporally forward direction can be referred to is the case where only B pictures referring to two pictures that are positioned in the forward direction shown in, for example, B6 in FIG. 5 as to B pictures or the case where no B picture is used. Each picture is divided into a block of, for example 16 (horizontally)×16 (vertically) pixels called macro block and the following processing is performed on each picture block by block.

The macro block that is read out from the frame memory 101 is inputted to the motion vector detecting unit 106. Here, motion vectors of the macro block of the current picture are detected using the pictures stored in the frame memory 105 as reference pictures. Pictures are stored in the frame memory 105 according to the following steps. First, signals are inputted to the prediction residual error decoding unit 104 from the prediction residual error coding unit 102. The adder 111 adds the signals that are inputted by the prediction residual error decoding unit 104 to the prediction image that is obtained by the motion compensation coding unit 107, and the frame memory 105 stores the added signal as a reference picture. In the case where intra picture prediction coding is performed, as the above-mentioned motion compensation is not required, the switch 113 is turned off.

Also, according to the motion vectors that are determined by the motion vector detecting unit 106, the motion compensation coding unit 107 generates a prediction image using motion vectors of the coded pictures that are stored in the motion vector recording unit 108 and the coded pictures that are stored in the frame memory 105. Also, differential motion vectors are inputted in the coded stream generation unit 103 from the motion compensation coding unit 107.

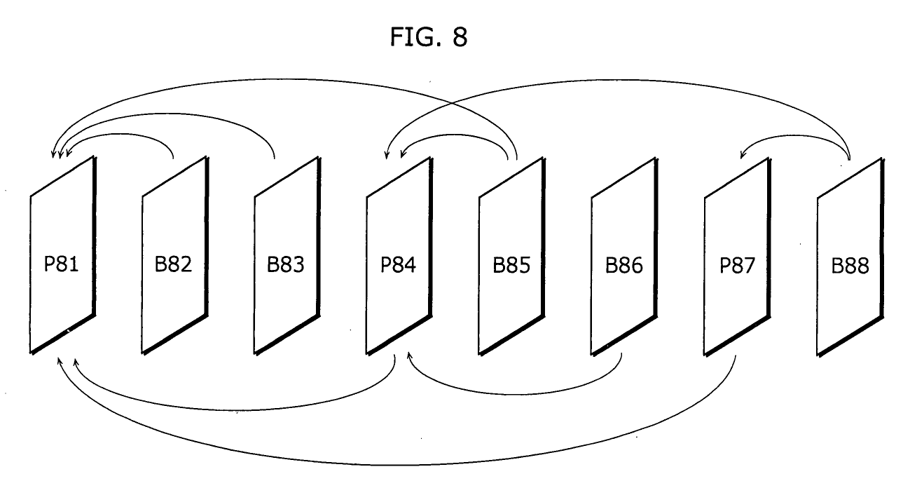

FIG. 8 shows the reference relations between pictures in the case where any picture in the temporally backward direction is not referred to when coding current picture. In this case, as reordering of pictures is not required, pictures are coded in display order. Prediction coding is performed on all B pictures that are included in the sequence with reference to one or more coded pictures that are positioned in the temporally forward direction. Therefore, using B pictures makes it possible to perform more efficient coding than the conventional low delay mode where only I pictures and P pictures are used.

The prediction image that is determined by the motion vectors obtained by the motion vector detection unit 106 are inputted in the subtracter 110, the picture of prediction residual errors are generated by calculating the differences between macro blocks of the reference picture and the picture to be coded, and the picture of prediction residual errors is coded in the prediction residual error coding unit 102.

The processing flow that has been explained up to this point is the operation in the case where inter picture prediction coding is selected, and the switch 112 switches to the intra picture prediction coding. Note that the switch 113 is turned off at the same time.

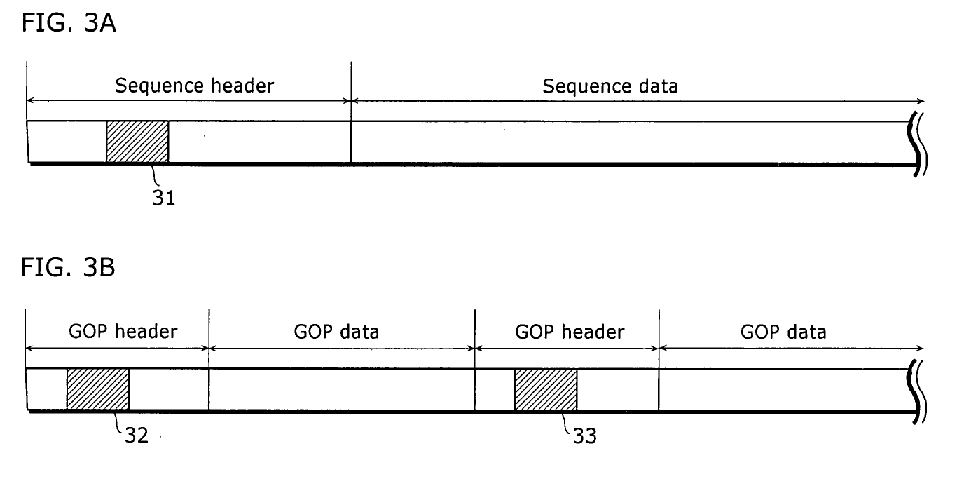

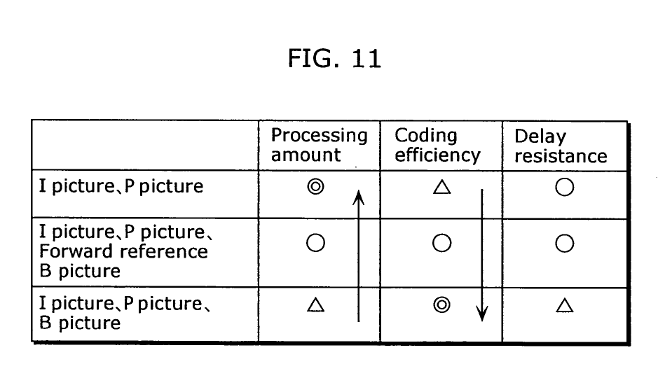

Lastly, the coded stream generation unit 103 performs a variable length coding on the control information such as motion vectors and the picture information and the like that is to be outputted from the prediction residual error coding unit 102 and generates a coded stream that is to be outputted in the last. At that time, as shown in FIG. 3A, the identification number shown in FIG. 4A or 4B that is specified by the prediction direction restriction indicating unit 109 is added to the header area of the sequence to be coded as the prediction direction restriction identification signal 31. In the case where the prediction direction restriction identification signal 31 is added to the sequence header, a restriction of the prediction direction is imposed on the whole moving picture that is to be coded. Note that it is also possible to switch the restriction of the prediction direction for each GOP by adding an identification number, which is shown in FIG. 4A or 4B, that is specified by the prediction direction restriction indicating unit 109 to the header part of the GOP as shown in the 32 and 33 of FIG. 3B. At this time, the signal to be added as an prediction direction restriction identification signal is determined with reference to the table shown in FIG. 4A as an example. According to the example of FIG. 4A, identification number “0” is selected in the case where no restriction of prediction direction is imposed, while identification number “1” is selected in the case where prediction direction is restricted to only forward direction, in other words, in the case where I pictures, P pictures and forward reference B pictures are used. Also, instead of using a table comprising only two categories shown in FIG. 4A as prediction direction restriction identification signals, it is also possible to use a table comprising three categories shown in FIG. 4B. Here, in addition to the two categories of FIG. 4A, it is possible to select a coding method where no B picture is used. This makes it possible to use an optimum coding method depending on the case by selecting identification number “1” in the case of avoiding the delays and the deterioration of the coding efficiency as much as possible or identification number “2” in the case of placing the priority on reducing the processing amount and avoiding the delays. In other words, the instruction from outside to the prediction direction control indication unit 109 is determined after taking into account the appropriate processing amount, efficiency and delays concerning the moving pictures to be coded. Also, as shown in FIG. 11, the processing amount becomes smaller in the case where I pictures and P pictures are used, the coding efficiency becomes highest in the case where all type pictures are used, and delays that occur when starting the transmission of pictures in coding and when starting the display of pictures in decoding are most likely to occur in the case where all type pictures are used. Note that how to assign identification numbers may be in a way different from the ones shown in FIGS. 4A and 4B. Also, picture data is included in the sequence data shown in FIG. 3A and the GOP data shown in FIG. 3B.

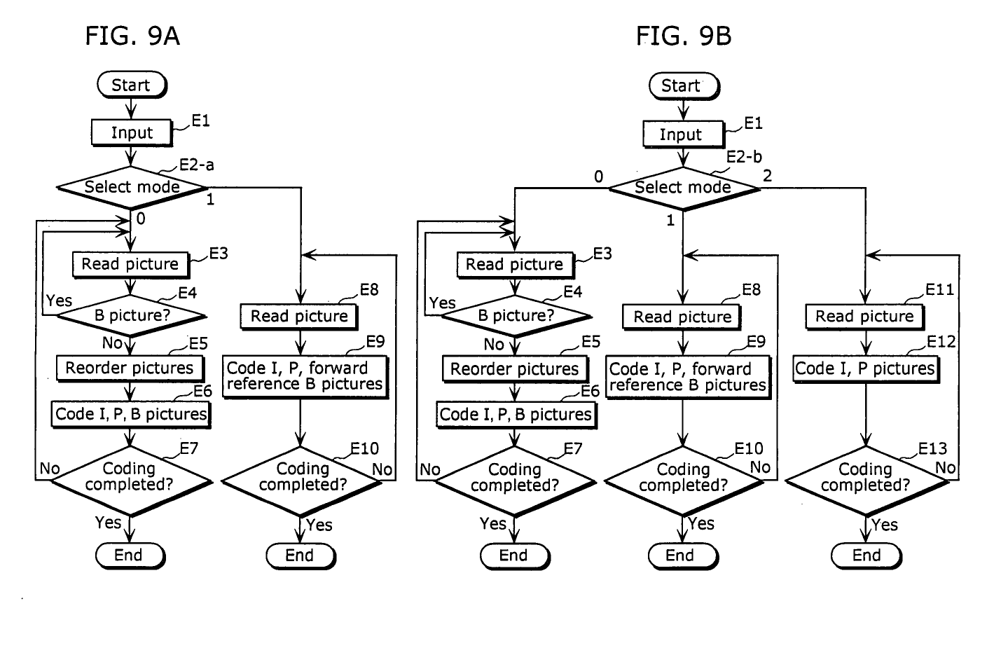

An example of the processing flow in the coding method shown in FIG. 1 at the time when the identification number shown in FIG. 4A is inputted to the prediction direction control indicating unit 109 will be explained with reference to FIG. 9A.

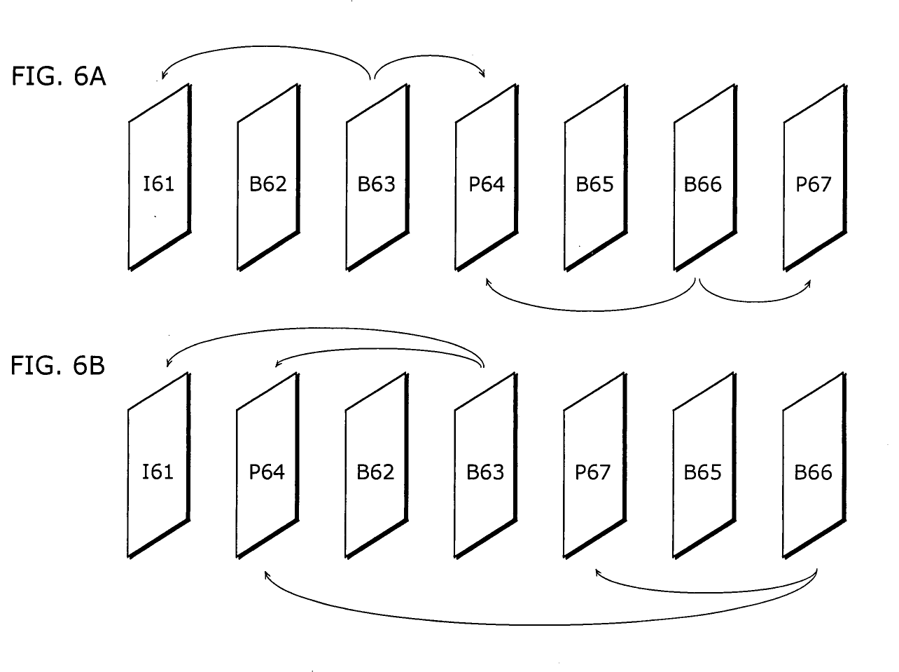

As soon as the identification number shown in FIG. 4A is inputted in E1, the operation mode for the identification number is selected in E2-a. In the case where the identification number is “0”, picture is read from the frame memory 101 (E3). In the case of coding the read picture as a B picture, the following picture is read (E3). At the time when the picture to be coded using a method where no B picture is used is read, these read pictures are reordered in coding order (E5). Considering the case of coding the picture sequence shown in FIG. 6A as an example, first, I picture I61 is coded as it is. Next, B pictures B62 and B63 are reordered in coding order after P picture P64 that is referred to by these B pictures B62 and B63 is read. FIG. 6B shows the picture sequence after pictures are reordered in coding order. After that, these pictures are coded in the reordering order in E6. Coding finishes in the case where the coding is completed by the coding in E6, while steps of E3 to E7 will be repeated after returning to E3 in the case where the coding has not been completed yet.

On the other hand, in the case where the identification number is “1” in E2-a, a single picture is read from the frame memory 101 in E8. As pictures in the backward direction are not referred to when coding I pictures, P pictures and forward reference B pictures, these pictures that are read in E9 are coded without the reordering shown in E5. FIG. 8 is an example of the picture sequence at that time. Pictures in the forward direction are not referred to when coding all the B pictures such as B82 and B83 in this picture sequence. Just as in the case of E7, coding finishes in the case where the coding is completed by the coding in E9, while steps of E8 to E10 will be repeated after returning to E8 in the case where the coding has not been completed yet.

Next, the processing flow in the coding method in the case where the identification number shown in FIG. 4B is inputted in the prediction direction control indication unit 109 will be explained with reference to FIG. 9B. Note that the steps that perform the same processing as the ones in FIG. 9A are given the same reference numbers, and explanations on the steps will be omitted.

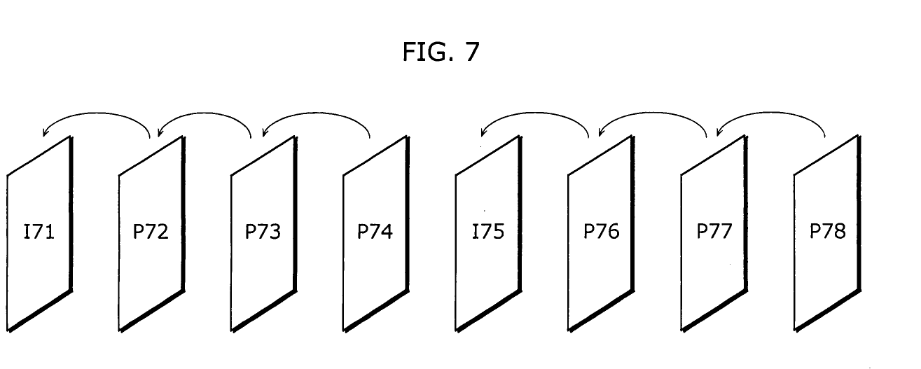

The processing flow of FIG. 9B differs from that of FIG. 9A in that additional judgment is made in E2-b because FIG. 4A includes three identification numbers and in that processing step E11, E12 and E13 are included as the operation mode corresponding to the identification number “2” that is different from the case of FIG. 4A. The operation mode corresponding to the identification number “2” in FIG. 4B performs coding with reference to only I pictures and P pictures, only E pictures and P pictures are coded in E12 without reordering the pictures read in E11. FIG. 7 shows an example of the picture sequence at that time. It is shown that this picture sequence is composed of only I pictures and P pictures that refer to pictures in the forward direction. Note that identification numbers may be inputted by someone externally, may be preset at hardware level or may be inputted indirectly at software level.

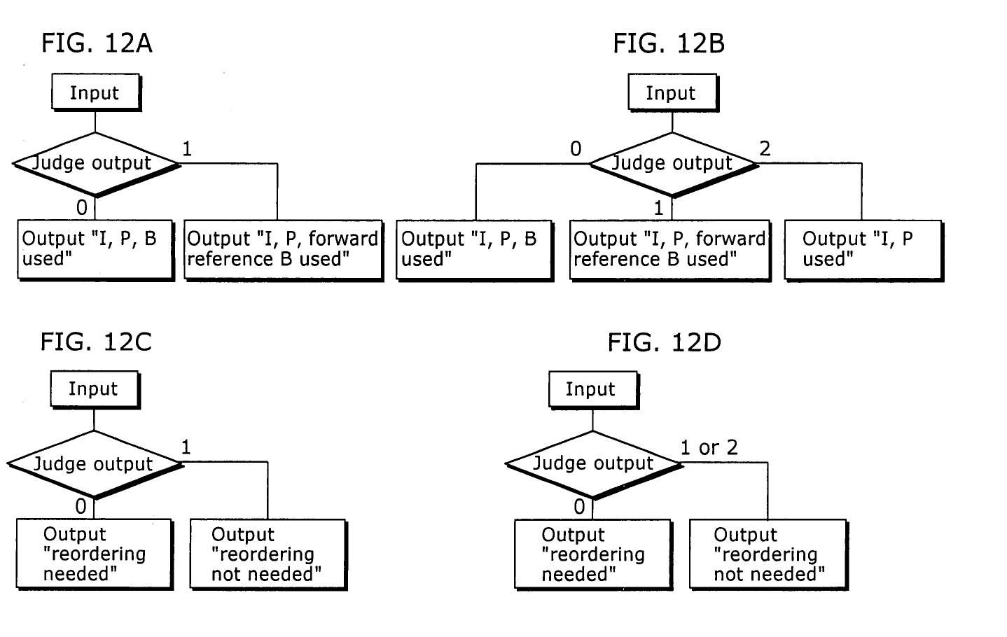

The signals are to be inputted in the coded stream generation unit 103 according to the procedure shown in FIG. 12 after the identification number shown in FIG. 4A or 4B is inputted in the prediction direction restriction indicating unit 109.

First, the case of using the identification number shown in FIG. 4A will be explained. As shown in FIG. 12A, the inputted identification numbers “0” and “1” are outputted to the coded stream generation unit 103 as they are. In other words, the identification numbers that are inputted in the prediction direction restriction indicating unit 109 are included in the prediction direction restriction identification signals 31, 32 and 33 in FIG. 3 as they are. Likewise, in the case of using the identification number shown in FIG. 4B, as shown in FIG. 12B, the identification numbers that are inputted in the prediction direction restriction indicating unit 109 are included in the prediction direction restriction identification signals 31, 32 and 33 shown in FIG. 3.

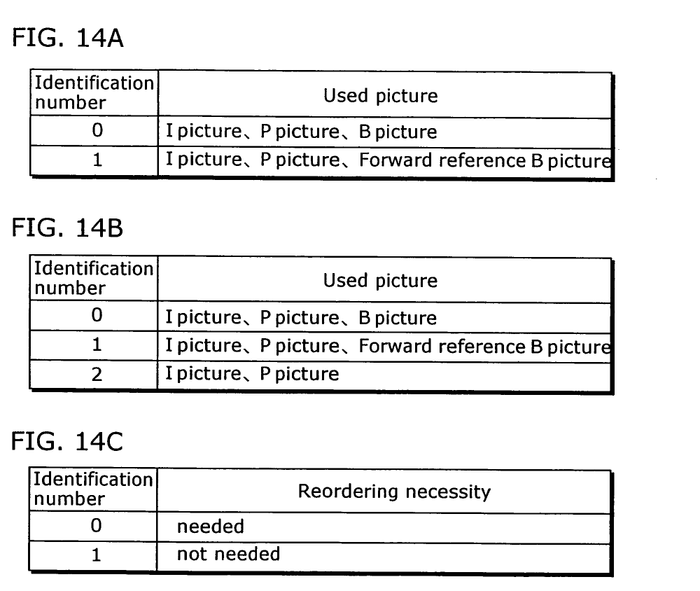

With the increase of identification numbers as shown in FIG. 4B, more bits are needed. Therefore, performing processing shown in FIG. 12C or 12D requires fewer number of bits than the processing shown in FIG. 12B does. FIG. 12C shows the processing procedure in the case where identification numbers shown in FIG. 4A are inputted in the prediction direction restriction indicating unit 109. As shown in FIG. 12C, it is judged whether the identification numbers inputted in the prediction direction restriction indicating unit 109 indicates whether there is a need of the reordering or not, and “0” is outputted in the case where these identification numbers indicate there is a need of the reordering while “1” is outputted in the case where these identification numbers do not indicate that there is a need of the reordering. Likewise, as shown in FIG. 12D, it is judged whether the identification numbers inputted in the prediction direction restriction indicating unit 109 indicates whether there is a need of the reordering or not, and in the case where the inputted identification number is “0”, “0” is outputted because the reordering is needed. On the other hand, as no reordering is needed because pictures that refer to pictures in the backward direction are not used in the case where the inputted identification numbers are “1” and “2”, “1” indicating that no reordering is needed is outputted. This makes it possible to reduce the bit amount because only the information on whether the reordering is needed or not is required to be indicated in the form of signal that is outputted to the coded stream generation unit 103 by the prediction direction restriction indicating unit 109 as shown in FIG. 14C. Especially, in the case where the number of identification numbers is many, identification number in FIG. 14C can be used for making a judgment on whether the reordering of pictures is necessary or not.

Also, using a B picture makes it possible to use the average picture of two reference pictures as a prediction image, which brings a possibility to improve the coding efficiency even in the case where the two reference pictures are positioned in the temporally forward direction.

Like the case where only two pictures in the forward direction are referred to when coding B pictures as described in the above-mentioned embodiment, only a single picture in the forward direction is referred to when coding B pictures that can be used as the pictures that do not need to be reordered. Further, the precondition of the motion compensation in the above-mentioned embodiment is to use the information on the motion vectors that are provided by the picture to be coded, but it is possible to use the coding method described in the above-mentioned embodiment even in the case of performing motion compensation called direct mode using the information on the coded block without the information on the motion vectors of the picture to be coded. Comparing with the case where B pictures are used in a prediction mode except the direct mode, the coding efficiency can further be improved because no information on motion vectors is provided in the case of B picture in the direct mode.

Also, a normal B picture on which motion compensation is performed backward and forward is effective as moving pictures in the case where a plurality of objects are overlapped, but almost same effect can be obtained also in the case where B pictures on which motion compensation is performed only in the forward direction are used. At the time of generating a prediction image from these two pictures in the motion compensation of a B picture, it is possible to perform highly efficient coding on the moving picture which influences the brightness of the whole display screen such as fade by taking a weighted average on the respective pixel values. As explained up to this point, the coding method described in the above-mentioned first embodiment makes it possible to omit the processing for reordering pictures inputted in the coding apparatus and minimize temporal delays caused by the coding processing. As most delays in coding processing are caused by reordering pictures, minimizing delays caused by reordering pictures has a significant meaning.

### Second Embodiment

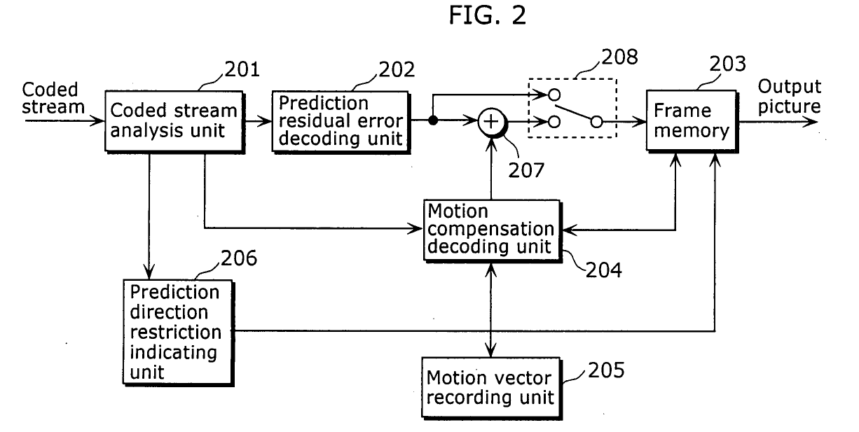

The moving picture decoding method in the second embodiment of the present invention will be explained with reference to a block diagram shown in FIG. 2. It is provided that the coded stream generated by using the moving picture coding method in the first embodiment is inputted in the following explanation, but the coded stream generated by using the moving picture coding method in the first embodiment is not necessarily be used, in other words, any other coded stream may be inputted as long as it has the same data structure.

First, the coded stream analysis unit 201 extracts, from the inputted coded stream, various kinds of pieces of information such as motion vector information and prediction residual error coding data. At the same time, it extracts, from the header area, the information on the prediction direction of inter picture prediction as the prediction direction restriction identification signal. FIG. 3A shows the coded stream in the case where the prediction direction restriction identification signal 31 is added to the sequence header. Also, 3B shows the coded stream in the case where the prediction direction restriction identification signal 32 and 33 are added to the GOP header areas. In this case, identification number shown in FIG. 4A or 4B is added as the prediction direction restriction identification signal depending on which coding method of the methods shown in FIG. 12A to 12D is employed.

The identification number that is extracted by the coded stream analysis unit 201 is outputted to the prediction direction restriction indicating unit 206, the information on motion vectors (differential motion vectors) are outputted to the motion compensation decoding unit 204, and the prediction residual error coding data are outputted to the prediction residual error decoding unit 202 respectively. The prediction direction restriction indicating unit 206 makes a judgment on the identification number that has been extracted in the coded stream analysis unit 201 as to whether it is the one indicating that pictures need to be reordered or it is the one indicating that pictures do not need to be reordered. After that, the information on whether pictures need to be reordered or not is inputted in the frame memory 203. The motion compensation decoding unit 204 generates a prediction image based on the information on the inputted motion vectors or the information on the motion vectors that are stored in the motion vector recording unit 205, regarding the decoded picture that are stored in the frame memory 203 as the reference picture. Under the condition that only pictures in the temporally forward direction can be referred to because of a restriction, if the motion compensation decoding unit 204 tries to refer to pictures in the temporally backward direction in decoding B pictures, the prediction restriction indicating unit 206 may detect an error or make an instruction for correcting the error.

A decoded picture is generated by inputting the generated prediction image to the adder 207 and by the adder 207 adding the generated prediction image to the picture of prediction residual errors that has been generated in the prediction residual error decoding unit 202. In the case where the prediction direction restriction indicating unit 206 does not impose any restriction on prediction directions, for example, in the case where the identification number shown in FIGS. 4A and 4B is “0”, these generated decoded pictures are reordered in display order in the frame memory 203. On the other hand, in the case where it imposes a restriction on pictures not to refer to, for example, in the case where the identification number shown in FIG. 4A or 4B is “1” or in the case where the identification number shown in FIG. 4B is “2”, it becomes possible to display pictures as they are in decoding order without reordering. Also, in the case where the identification number is “1”, it is possible to decode the generated coded stream using the coded method that makes it possible to prevent delays from occurring and also minimize deterioration of the coding efficiency as much as possible. Also, in the case where the identification number is “2”, it is possible to realize consistent decoding of the coded stream that is generated using the coding method, placing higher priority on reducing the processing amount in decoding and preventing delays from occurring at the time of displaying pictures. Note that how to assign identification numbers may be in a way different from the ones shown in FIGS. 4A and 4B. In the case where the prediction direction restriction signal in a signal of the coded stream that is inputted by the coded stream analysis unit 201 is the one capable of identifying the type of the identification number, the control signal informing the prediction direction control indicating unit 206 of that pictures need to be reordered is inputted in the case where the identification number shown in FIG. 4B is “o”, while the control signal informing the prediction direction control indicating unit 206 of that pictures do not need to be reordered is inputted in the case where the identification number shown in FIG. 4B is “1” or “2”.

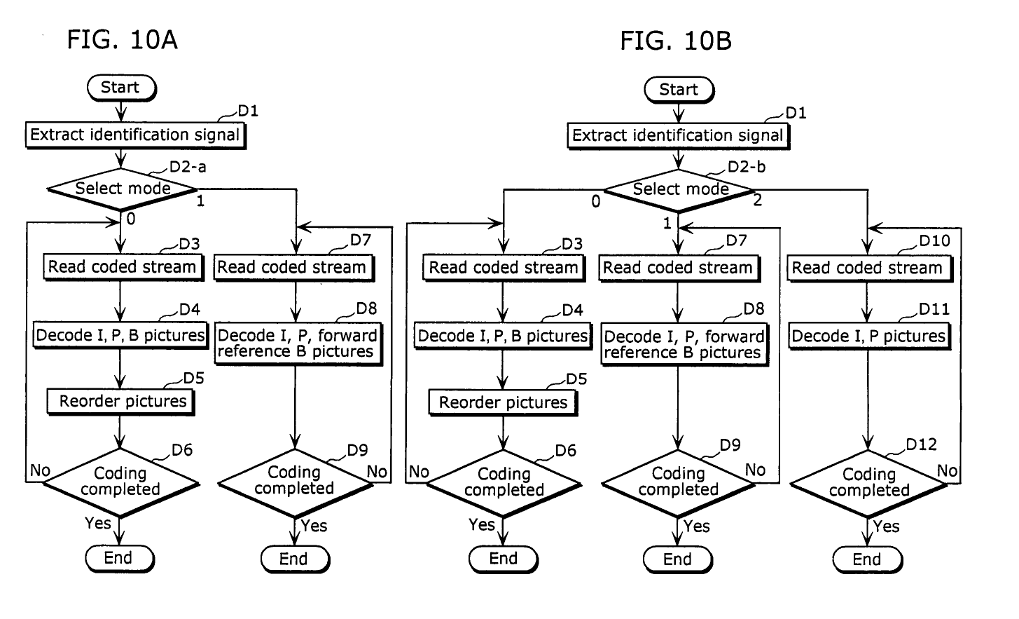

The decoding procedure in the case where prediction direction restriction identification numbers are coded according to the procedure shown in FIG. 12A will be explained with reference to FIG. 10A. Note that identification numbers “0” and “1” correspond to the identification numbers shown in FIG. 4A respectively and shown in FIG. 14A. First, an identification number is extracted from the inputted coded stream in D1, and an operation mode is selected in D2-a according to the identification number. The coded stream is read by D3 in the case where the identification number is “0”, and pictures in it are decoded in the reading order in D4. Further, the decoded pictures are reordered to the display order (D5). As an example, considering the case of the coded stream where pictures are reordered to the coding order shown in FIG. 6B, first, I61 that is an I picture is coded as it is and displayed. Next, P64 that is a P picture needs to be waited until the following pictures B62 and B63 are decoded and displayed because it is displayed after B62 and B63 are displayed. In the last, pictures that are decoded in the order shown in FIG. 6A are displayed. In the case where decoding of all the pictures has not completed yet, the above-mentioned steps D3 to D6 will be repeated after returning to D3.

On the other hand, in the case where the identification number is “1” in D2-a, the coded stream that is composed of I pictures, P pictures and forward reference B pictures are read. As the I pictures, P pictures and forward reference B pictures are pictures that do not refer to pictures in the backward direction, pictures are coded in the reading order shown in D8 without the reordering shown in D5. An example of a picture sequence at that time will be shown in FIG. 8. All the B pictures such as B82 and B83 in this picture sequence are pictures that refer to pictures in the forward direction. Decoding finishes like in D6 in the case where the decoding of all the pictures has been completed, while steps D7 to D9 will be repeated after returning to D7 in the case where the decoding has not been completed yet. Note that an operation mode (D2-a) is selected in the prediction direction control indicating unit 206.

Next, the decoding procedure in the case where a prediction direction restriction identification number is coded according to the procedure shown in FIG. 12B will be explained with reference to FIG. 10B. The steps that perform the same processing as the ones in FIG. 10A are given the same reference numbers, and explanations on them will be omitted. The prediction direction control identification signals are shown in FIG. 14B.

The processing flow of FIG. 10B differs from FIG. 10A in that additional judgment is made in D2-b because FIG. 4B includes three identification numbers and in that processing step D10, D11 and D12 are included as the operation mode corresponding to the identification number “2” that is different from the case of FIG. 4A. As the operation mode corresponding to the identification number “2” in FIG. 4B performs coding with reference to only I pictures and P pictures, only I pictures and P pictures are coded in D11 without reordering the pictures read in D10. FIG. 7 shows an example of the picture sequence at that time. FIG. 7 shows that this picture sequence is composed of only I pictures and P pictures that refers to pictures in the forward direction. Note that an operation mode (D2-b) is selected in the prediction direction control indicating unit 206.

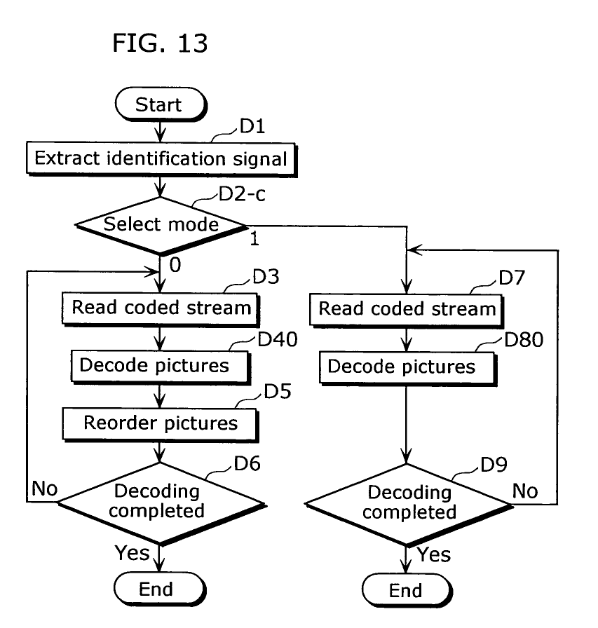

Further, the decoding procedure in the case where a prediction direction restriction identification number is coded according to the procedure shown in FIG. 12C will be explained with reference to FIG. 13. FIG. 14C shows identification numbers. In this case, the procedure is the same as the one shown in FIG. 10A. The procedure differs in that the prediction direction restriction identification signal indicates only whether pictures need to be reordered or not, which makes a difference between the meaning of the operation mode selection in D2-a of FIG. 10A and the meaning of the operation mode selection in D2-c of FIG. 13. After selecting a mode in D2-c, the coded stream is read, the read pictures are decoded (D40, D80), pictures are not reordered in the case where the mode requires the reordering while pictures are not reordered in the case where the mode does not require the reordering. This mode selection is performed in the prediction direction control indicating unit 206. The decoding procedure in the case where a prediction direction restriction identification number is coded according to the procedure of FIG. 12D is similar. FIG. 14C shows the identification numbers in this case. The coded stream to be read and the type of the picture to be decoded that are used in this case are different from the ones that are used in the case where pictures are coded according to the procedure shown in FIG. 12C.

The above-explained embodiments are concerning the operations on the coded stream on which inter picture prediction coding is performed, and a switch 208 switches to the decoding processing on the coded stream on which intra picture prediction coding is performed.

The decoding method described in the above-mentioned second embodiment makes it possible to omit the processing for switching the order of the decoded pictures so as to display them and avoid temporal delays caused by reordering pictures in decoding processing as explained up to this point. As most delays in decoding processing are caused by reordering pictures, minimizing delays caused by reordering pictures has a significant meaning.

### Third Embodiment

The case of a P picture on which inter picture prediction coding is performed with reference to a single picture in the temporally forward direction has been explained in the first and the second embodiments mentioned above. In this embodiment, the case of a P picture on which inter picture prediction coding is performed with reference to a single picture in the temporally forward or backward direction will be explained.

For the convenience of explanation, pictures on which inter picture prediction coding is performed with reference to a single picture in the forward direction are called forward prediction P pictures and pictures on which inter picture prediction coding is performed with reference to a single picture in the backward direction are called backward prediction P pictures from here.

As to the coding method and the decoding method in this embodiment, the points different from the ones in the first and the second embodiments will be focused on in the following explanations, but the same points will be omitted.

Identification numbers in this embodiment are basically the same as FIGS. 4A, 4B, 14A, 14B and 14C except the case in the following explanation. To be more specific, “P picture” in the case where an identification number is “0” in FIG. 4A and FIG. 14A shall read “forward prediction P picture and backward prediction P picture”, and “P picture” in the case where an identification number is “1” in FIG. 4A and FIG. 14A shall read “forward prediction P picture” respectively. As a result, pictures need to be reordered in the case where the identification number is “0”, while pictures need not to be reordered in the case where the identification number is “1”.

Likewise, “P picture” in the case where an identification number is “0” in FIG. 4B and FIG. 14B shall read “forward prediction P picture and a backward prediction P picture”, and “P picture” in the case where an identification number is “1” in FIG. 4B and FIG. 14B shall read “forward prediction P picture” respectively. As a result, pictures need to be reordered in the case where the identification number is “0”, while pictures need not to be reordered in the case where the identification number is “1” or “2”.

In this way, the types of P pictures whose identification numbers indicate as available are different from the ones in the first embodiment and the second embodiment, but whether each identification number indicates a need to reorder pictures or not is the same.

Also, it is the same as FIGS. 9A and 9B except that the coding method in this embodiment shall read as will be explained below. To be more specific, “P” picture in step E6 shall read “forward prediction P and backward prediction P” picture, while “P” picture in step E9 and E12 shall read “forward prediction P” picture.

Likewise, it is the same as FIGS. 10A and 10B except that the decoding method in this embodiment shall read as will be explained below. To be more specific, “P” picture in step D4 shall read “forward prediction P and backward prediction P” picture, while “P” pictures in step D8 and D11 shall read “forward prediction P” pictures.

As explained up to this point, with the coding method and the decoding method of moving pictures in this embodiment, it is possible to obtain the same result as the first and the second embodiments even in the case where inter picture coding is performed on a P picture with reference to a single picture that is positioned in the forward direction or in the backward direction.

The signal for identifying a prediction direction restriction in each embodiment mentioned above may be data to be set in a coded stream that is to be generated by the coded stream generating unit 103 such as i) the data indicating delay time in display (called display delay data) or ii) the data indicating the number of pictures in reordering (called data concerning the number of pictures in reordering). Display delay data i) is the data indicating the delay time between the time when a picture has decoded and the time when the decoded picture of the frame memory 203 has displayed (the unit of the delay time is, for example, the number of a clock that is equivalent to the number of pictures). In this case, the signal for identifying a prediction direction restriction indicates that no reordering is necessary by making the data concerning the delay time shown in the display delay data “0”. Data concerning the number of pictures in reordering ii) is the data indicating the largest difference between the picture decoding order and the picture displaying order that is caused by the reordering. In this case, the signal for identifying a prediction direction restriction indicates that no reordering is necessary by making the number of pictures in ordering “0”.

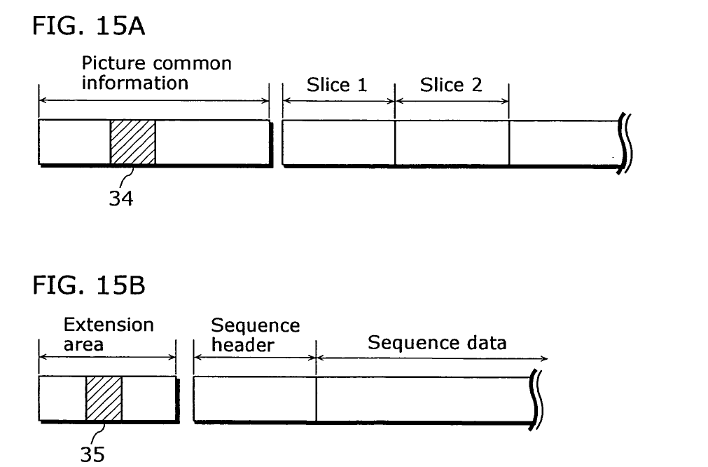

Also, the coded stream generation unit 103 may set a signal for identifying a prediction direction restriction in the sequence header shown in FIG. 3A as the signal for identifying a prediction direction restriction 31, may set signals for identifying a prediction direction restriction in the GOP header shown in FIG. 3B as the signals for identifying a prediction direction restriction 32 and 33, may set a signal for identifying a prediction direction restriction in the picture common information area shown in FIG. 15A as the signal for identifying a prediction direction restriction 34, may set a signal for identifying a prediction direction restriction in the extension area shown in FIG. 15B as the signal for identifying a prediction direction restriction 35. The picture common information area is the area where the pieces of information that are referred to by a single or a plurality of pictures in common are described and the extension area is the area where the pieces of information that are a help for decoding are described, and those pieces of information are not necessarily used. These areas may be set at arbitrary locations in a coded stream.

In the explanation up to this point, a motion compensation is performed by generating a prediction image with reference to a single coded picture in the case of a P picture or with reference to a single or two coded pictures in the case of a B picture, but the description also indicates the number of coded pictures that can be referred to for each block on which motion compensation is performed. For example, under the condition that a plurality of coded pictures (for example five pictures) per a single picture to be coded are permitted to be referred to, the processing can also be performed in the same way by using an alternate operation of selecting the optimum one or two pictures among them for each block to be coded or decoded and performing motion compensation using blocks in the selected pictures.

### Forth Embodiment

In addition, it becomes possible to easily execute the processing that is described in each embodiment mentioned above in an independent computer system by recording, in a recording medium such as a flexible disc, the coding program, the decoding program and coded streams (data streams) for realizing the structure of the coding processing and the decoding processing that are described in each embodiment mentioned above.

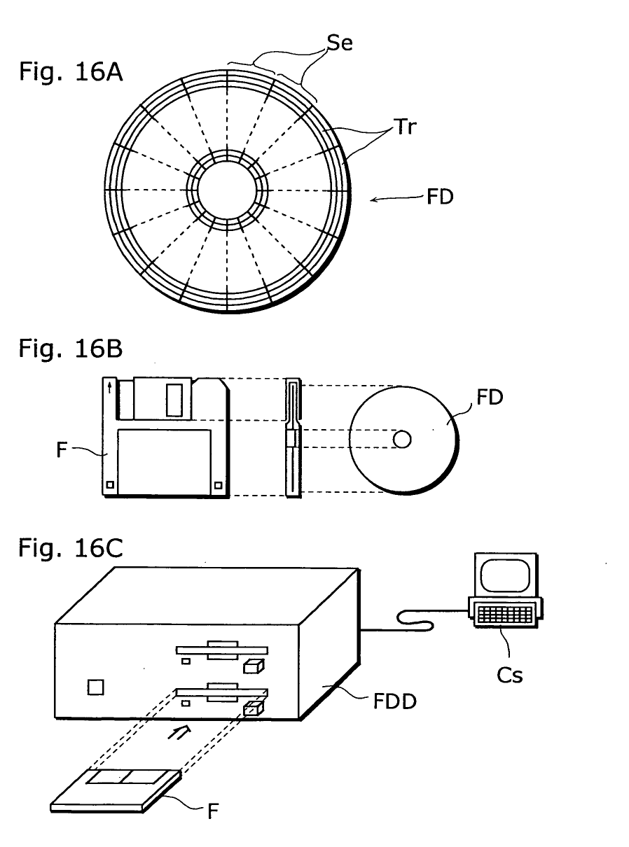

FIG. 16 is a diagram for explaining the case of performing, in a computer system, the coding processing or the decoding processing in the above-mentioned first and second embodiments using a flexible disc that stores the coding program and the decoding program.

FIG. 16B shows a flexible disc and the front view and the cross-sectional view of the appearance of the flexible disc and FIG. 16A shows an example of a physical format of a flexible disc as a recording medium body. A flexible disc (FD) is contained in a case F, a plurality of tracks (Tr) are formed concentrically on the surface of the disc from the periphery into the inner radius of the disc, and each track is divided into 16 sectors (Se) in the angular direction. Therefore, in the case of the flexible disc storing the above-mentioned program, the data as the program is recorded in an area allocated for it on the flexible disc (FD).

Also, FIG. 16C shows the structure for recording and reading out the program on the flexible disc (FD). When the program is recorded on the flexible disc (FD), the computer system (Cs) writes the data as a program via a flexible disc drive. When the coding method and the decoding method mentioned above are constructed in the computer system by the program on the flexible disc, the program is read out from the flexible disc through a flexible disc drive and transferred to the computer system. Note that the above-mentioned explanation is made using the flexible disc as a recording medium, the explanation may also be made using an optical disc. Also, the recording medium is not limited to flexible discs, and a recording medium such as an IC card, a ROM cassette and the like can also be used.

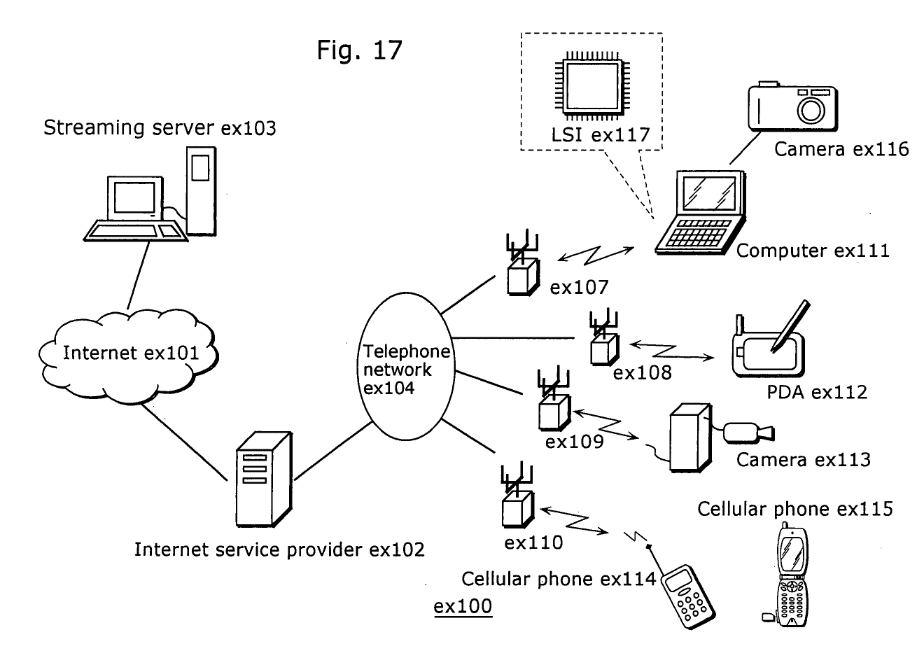

Also, the coding method and the decoding method described in the above mentioned embodiment can be implemented, in a form of a semiconductor such as an LSI, in a mobile communication device such as a cellular phone, a car navigation system and the like or a camera such as a digital video camera, a digital steel camera and the like. Also, as the implementation form, the following three forms are conceivable: a sending/receiving type terminal that has both a coding apparatus and a decoding apparatus, a sending terminal that has only a coding apparatus and a receiving terminal that has only a decoding apparatus. Applications will be explained below with reference to FIG. 17 to FIG. 20.

FIG. 17 is a block diagram showing the overall configuration of a content supply system ex100 for realizing content distribution service. The area for providing communication service is divided into cells of desired sizes, and cell sites ex107 to ex110 of fixed wireless stations are placed in the respective cells.

This content supply system ex100 is connected to each apparatus such as a computer ex111, a Personal Digital Assistant (PDA) ex112, a camera ex113, a cellular phone ex114 and a cellular phone with a camera ex115 via, for example, a combination of the Internet ex101, an Internet service provider ex102, a telephone network ex104 and cell sites ex107 to ex110. However, the content supply system ex100 is not limited to the configuration as shown in FIG. 17, and may be connected to a combination of any of them. Also, each apparatus can be connected directly to the telephone network ex104, not through the cell sites as fixed radio stations ex107 to ex110.

The camera ex113 is an apparatus capable of shooting video (moving pictures) such as a digital video camera. The cell phone can be a cell phone of a Personal Digital Communications (PDC) system, a Code Division Multiple Access (CDMA) system, a Wideband-Code Division Multiple Access (W-CDMA) system or a Global System for Mobile Communications (GSM) system, a Personal Handy-phone system (PHS) or the like.

Also, A streaming server ex103 is connected to the camera ex113 via the cell site ex109 and the telephone network ex104, which enables live distribution or the like using the camera ex113 based on the coded data transmitted from the user. Either the camera ex113 or the server for transmitting the data can code the shot data. Also, the moving picture data shot by a camera ex116 can be transmitted to the streaming server ex103 via the computer ex111. The camera ex116 is an apparatus capable of shooting still and moving pictures such as a digital camera. In this case, either the camera ex116 or the computer ex11 can code the moving picture data. Also, an LSI ex117 included in the computer ex111 or the camera ex116 performs coding processing. Software for coding and decoding pictures can be integrated into any type of storage media (such as CD-ROMs, flexible discs, hard discs and the like) that is a recording medium which is readable by the computer ex111 or the like. Furthermore, a cellular phone with a camera ex115 can transmit the moving picture data. This moving picture data is the data coded by the LSI included in the cellular phone ex115.

The contents supply system ex100 codes contents (such as a music live video) shot by users using the camera ex113, the camera ex116 or the like in the same manner as the above-mentioned embodiments and transmits them to the streaming server ex103, while the streaming server ex103 makes stream distribution of the contents data to the clients upon their request. The clients include the computer ex111, the PDA ex112, the camera ex113, the cellular phone ex114 and so on that are capable of decoding the above-mentioned coded data. In this way, the contents supply system ex100 enables the clients to receive and reproduce the coded data, and further to receive, decode and reproduce the data in real time so as to realize personal broadcasting.

When each apparatus in this system performs coding or decoding, the moving picture coding apparatus and the moving picture decoding apparatus can be used, as described in the above-mentioned embodiments.

A cellular phone will be explained as an example of the apparatus.

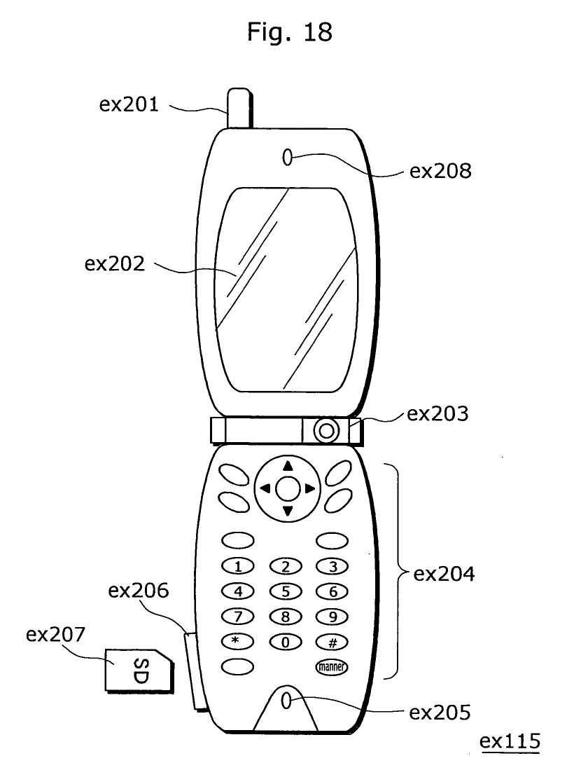

FIG. 18 is a diagram showing the cellular phone ex115 using the moving picture coding apparatus and the moving picture decoding apparatus explained in the above-mentioned embodiments. The cellular phone ex115 has an antenna ex201 for communicating with the cell site ex110 via radio waves, a camera unit ex203 capable of shooting moving and still pictures such as a CCD camera, a display unit ex202 such as a liquid crystal display for displaying a moving picture shot by the camera unit ex203, the data obtained by decoding the moving picture and the like received by the antenna ex201, a body unit including a set of operation keys ex204, a voice output unit ex208 such as a speaker for outputting voices, a voice input unit 205 such as a microphone for inputting voices, a storage medium ex207 for storing coded or decoded data such as data of moving or still pictures shot by the camera, data of received e-mail and data of moving or still pictures, and a slot unit ex206 operable to attach the storage medium ex207 to the cellular phone ex115. The storage medium ex207 is equipped with a flash memory element, a kind of Electrically Erasable and Programmable Read Only Memory (EEPROM) that is an electrically erasable and rewritable nonvolatile memory, in a plastic case such as SD cards.

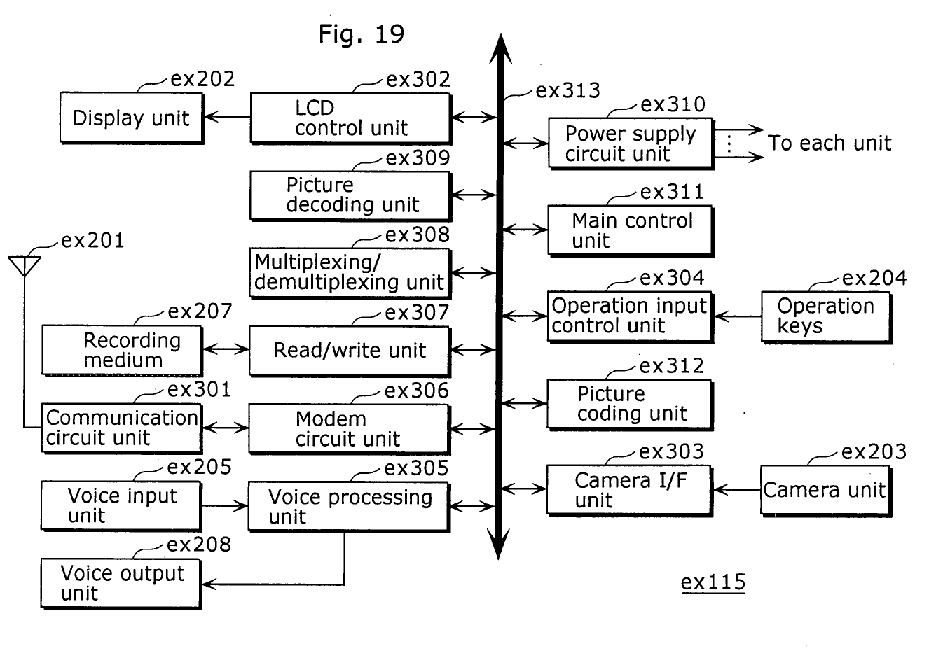

Further, the cellular phone ex115 will be explained with reference to FIG. 19. In the cellular phone ex115, a main control unit ex311, which is operable to perform centralized control on each unit of the body unit including the display unit ex202 and operation keys ex204, is connected to a power supply circuit unit ex310, an operation input control unit ex304, a picture coding unit ex312, a camera interface unit ex303, a Liquid Crystal Display (LCD) control unit ex302, a picture decoding unit ex309, a demultiplexing unit ex308, a recording and reproducing unit ex307, a modem circuit unit ex306 and a voice processing unit ex305 to each other via a synchronous bus ex313.

When a call-end key or a power key is turned ON by a user's operation, the power supply circuit unit ex310 supplies respective components with power from a battery pack so as to activate the digital cellular phone with a camera ex115 for making it into a ready state.

In the cell phone ex115, the voice processing unit ex305 converts the voice signals received by the voice input unit ex205 in conversation mode into digital voice data under the control of the main control unit ex311 including a CPU, a ROM, a RAM and the like, the modem circuit unit ex306 performs spread spectrum processing of the digital voice data, and the communication circuit unit ex301 performs digital-to-analog conversion and frequency transform of the data so as to transmit it via the antenna ex201. Also, in the cellular phone ex115, the communication circuit unit ex301 amplifies the data received by the antenna ex201 in conversation mode and performs frequency transform and analog-to-digital conversion for the data, the modem circuit unit ex306 performs inverse spread spectrum processing of the data, and the voice processing unit ex305 converts it into analog voice data so as to output it via the voice output unit ex208.

Furthermore, when transmitting e-mail in data communication mode, the text data of the e-mail inputted by operating the operation keys ex204 on the body unit is sent out to the main control unit ex311 via the operation input control unit ex304. In the main control unit ex311, after the modem circuit unit ex306 performs spread spectrum processing of the text data and the communication circuit unit ex301 performs digital-to-analog conversion and frequency transform for it, the data is transmitted to the cell site ex110 via the antenna ex201.

When picture data is transmitted in data communication mode, the moving picture data shot by the camera unit ex203 is supplied to the picture coding unit ex312 via the camera interface unit ex303. When the picture data is not transmitted, it is also possible to display the picture data shot by the camera unit ex203 directly on the display unit 202 via the camera interface unit ex303 and the LCD control unit ex302.

The picture coding unit ex312, which includes the moving picture coding apparatus explained in the present invention, compresses and codes the picture data supplied from the camera unit ex203 using the coding method used for the moving picture coding apparatus described in the above-mentioned embodiments so as to transform it into coded picture data, and sends it out to the demultiplexing unit ex308. Also, at this time, the cellular phone ex115 sends out the voices received by the voice input unit ex205 during shooting by the camera unit ex203 to the demultiplexing unit ex308 as digital voice data via the voice processing unit ex305.

The demultiplexing unit ex308 multiplexes the coded picture data supplied from the picture coding unit ex312 and the voice data supplied from the voice processing unit ex305 using a predetermined method, the modem circuit unit ex306 performs spread spectrum processing on the multiplexed data obtained as a result of the multiplexing, and the communication circuit unit ex301 performs digital-to-analog conversion and frequency transform of the data for transmitting via the antenna ex201.

As for receiving data of a moving picture file which is linked to a Web page or the like in data communication mode, the modem circuit unit ex306 performs spread spectrum processing of the data received from the cell site ex110 via the antenna ex201, and sends out the multiplexed data obtained as a result of the processing to the demultiplexing unit ex308.

Also, in order to decode the multiplexed data received via the antenna ex201, the demultiplexing unit ex308 separates the multiplexed data into a bit stream of picture data and a bit stream of voice data, and supplies the current coded picture data to the picture decoding unit ex309 and the current voice data to the voice processing unit ex305 respectively via the synchronous bus ex313.

Next, the picture decoding unit ex309, which includes the moving picture decoding apparatus explained in the above invention, decodes the bit stream of picture data using the decoding method corresponding to the coding method described in the above-mentioned embodiments to generate reproduced moving picture data, and supplies this data to the display unit ex202 via the LCD control unit ex302, and thus, for instance, the moving picture data included in a moving picture file linked to a Web page is displayed. At the same time, the voice processing unit ex305 converts the voice data into analog voice data, and supplies this data to the voice output unit ex208, and thus, for instance, voice data included in a moving picture file linked to a Web page is reproduced.

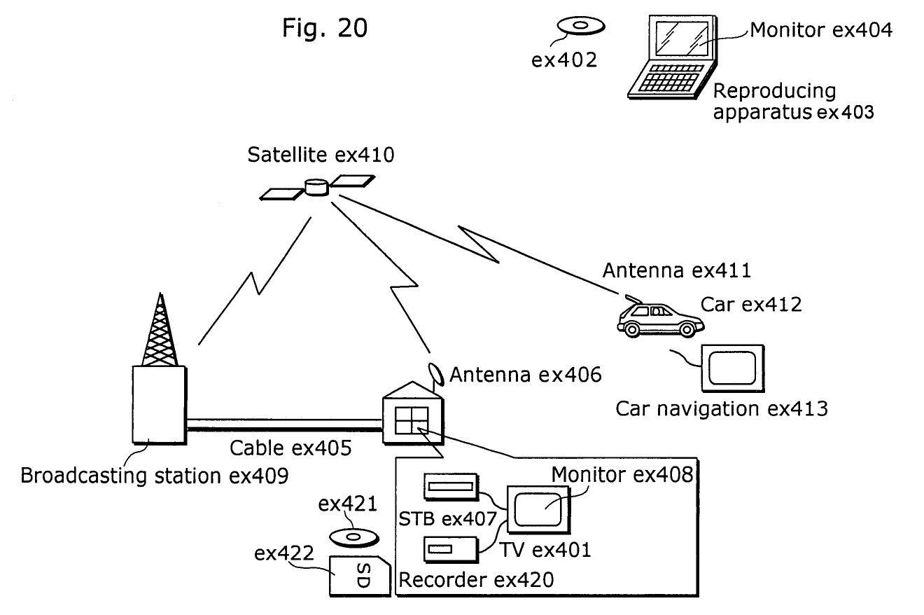

The present invention is not limited to the above-mentioned system, and at least either the moving picture coding apparatus or the moving picture decoding apparatus in the above-mentioned embodiments can be incorporated into a digital broadcasting system as shown in FIG. 20. Such ground-based or satellite digital broadcasting has been in the news lately. More specifically, a bit stream of video information is transmitted from a broadcast station ex409 to a communication or a broadcast satellite ex410 via radio waves. Upon receipt of it, the broadcast satellite ex410 transmits radio waves for broadcasting, a home-use antenna ex406 with a satellite broadcast reception function receives the radio waves, and a television (receiver) ex401, a set top box (STB) ex407 or the like decodes and reproduce the bit stream. Also, the moving picture decoding apparatus described in the above-mentioned embodiments can be implemented in the reproduction apparatus ex403 for reading out and decoding the bit stream recorded on a storage medium ex402 that is a recording medium such as a CD, a DVD and the like. In this case, the reproduced video signals are displayed on a monitor ex404. It is also conceived to implement the moving picture decoding apparatus in the set top box ex407 connected to a cable ex405 for a cable television or the antenna ex406 for satellite and/or ground-based broadcasting so as to reproduce them on a monitor ex408 of the television. The moving picture decoding apparatus may be incorporated into the television, instead of in the set top box. Or, a car ex412 having an antenna ex411 can receive signals from the satellite ex410, the cell site ex107 or the like for reproducing moving pictures on a display apparatus such as a car navigation system ex413.

Furthermore, the moving picture coding apparatus described in the above-mentioned embodiments can code picture signals for recording on a recording medium. As a concrete example, there is a recorder ex420 such as a DVD recorder for recording picture signals on a DVD disc ex421 and a disc recorder for recording them on a hard disc. Further, they can be recorded on an SD card ex422. If the recorder ex420 includes the moving picture coding apparatus described in the above-mentioned embodiment, the picture signals recorded on the DVD disc ex421 or the SD card ex422 can be reproduced for display on the monitor ex408.

Note that a conceivable configuration of the car navigation system ex413 is the configuration obtained by eliminating the camera unit ex203, the camera interface unit ex303 and the picture coding unit ex312 from existing components in FIG. 19. The same goes for the computer ex111, the television (receiver) ex401 and the like.

In addition, three types of implementation can be conceived for a terminal such as the above-mentioned cell phone ex114, a sending/receiving terminal implemented with both a moving picture coding apparatus and a moving picture decoding apparatus, a sending terminal implemented with a moving picture coding apparatus only, and a receiving terminal implemented with a moving picture decoding apparatus only.

As described above, it is possible to use the moving picture coding method or the moving picture decoding method in the above-mentioned embodiments in any of the above-mentioned apparatuses and systems, and by doing so, the effects explained in the above embodiments can be obtained.

Also, the embodiments of this present invention is not limited to this and may be varied or modified in many ways without being regarded as a departure from the spirit and scope of the invention.

### Industrial Applicability

The present invention is useful for a coding apparatus and a decoding apparatus, the coding apparatus being for coding a data stream that can be made of i) an I picture that is coded by performing inter picture prediction coding and ii) inter picture prediction pictures that are coded by performing inter picture prediction coding where a single or two pictures in the forward direction or the backward direction in display order are referred to and the decoding apparatus being for decoding the data stream.

1. A data stream that is capable of including an I picture coded by intra picture prediction coding and an inter picture prediction picture coded by inter picture prediction coding where a picture in a forward direction or a backward direction in display order is referred to,
the data stream comprising sequence data and an identification signal,
wherein the sequence data is made of a combination of the inter picture prediction pictures coded by referring to only a picture in the forward direction and the I picture, and
the identification signal indicates that a reordering of the coded pictures in decoding the data stream is unnecessary in the case where no picture that is coded by referring to a picture in the backward direction is included in the sequence data.

2. The data stream according to claim 1,
wherein the data stream is capable of including a forward prediction B picture, a backward prediction B picture, a P picture and the I picture,
the forward prediction B picture is the picture coded by inter picture prediction coding where up to two pictures for each block is referred to, the two pictures belonging to pictures in the forward direction,
the backward prediction B picture is the picture coded by inter picture prediction coding where up to two pictures for each block is referred to, the two pictures belonging to pictures including at least a single picture in the backward direction,
the P picture is the picture coded by inter picture prediction coding where a single picture that belongs to pictures in the forward direction is referred to for each block, and
the sequence data is made of the I picture, the forward prediction B picture and the P picture.

3. The data stream according to claim 2,
wherein the inter picture prediction pictures include the backward prediction B picture, and
the identification signal indicates that the reordering of the pictures is necessary in the case where the backward prediction B picture is included in the sequence data.

4. The data stream according to claim 1,
wherein the data stream is capable of including a forward prediction P picture, a backward prediction P picture and the I picture,
the forward prediction P picture is the picture coded by inter picture prediction coding where a single picture that belongs to pictures in the forward direction is referred to for each block,
the backward prediction P picture is the picture coded by inter picture prediction coding where a single picture is referred to for each block, the single picture belonging to pictures including at least a single picture in the backward direction, and
the sequence data is made of the I picture and the forward prediction P picture.

5. The data stream according to claim 4,
wherein the inter picture prediction pictures include the backward prediction P picture, and
the identification signal indicates that the reordering of the pictures is necessary in the case where the backward prediction P picture is included in the sequence data.

6. The data stream according to claim 1,
wherein the identification signal is the data indicating delay time between time when a picture has decoded and time when the decoded picture has displayed and indicates that the reordering of pictures is unnecessary in the case where the delay time is set at “0”.

7. The data stream according to claim 1,
wherein the identification signal is data indicating a largest difference, which is caused by the reordering of pictures, between a decoding order and a display order, and indicating that the reordering of pictures is unnecessary in the case where the largest difference is set at “0”.

8. A computer-readable data recording medium for recording a data stream according to claim 1.

9. A coding method for coding pictures using an I picture to be coded by intra picture prediction coding and an inter picture prediction picture to be coded by inter picture prediction coding where a picture in the forward direction or in the backward direction in display order from a picture to be coded is referred to, comprising the steps of:
receiving an instruction indicating that coding is performed using pictures made of the I picture and the inter picture prediction picture coded by referring to only a picture in the forward prediction direction;
outputting an identification signal indicating that a reordering of pictures is unnecessary in the case of receiving the instruction; and
coding the combination of pictures in display order together with the identification signal without the reordering.

10. The coding method according to claim 9,
wherein the coded inter picture prediction pictures are capable of including a forward prediction B picture, a backward prediction B picture and a P picture, the forward prediction B picture being coded by inter picture prediction coding where up to two pictures that belong to pictures in the forward direction is referred to for each block, the backward prediction B picture being coded by inter picture prediction coding where up to two pictures for each block is referred to, the two pictures belonging to pictures including at least a single picture in the backward direction and the P picture being coded by referring to a single picture in the forward direction for each block, and
the instruction indicates that coding is performed using a combination of the forward prediction B pictures, the I picture and the P picture.

11. The coding method according to claim 9,
wherein the coded inter picture prediction pictures are capable of including a forward prediction P picture to be coded by inter picture prediction coding where a single picture that belongs to pictures in the forward direction is referred to for each block and a backward prediction P picture to be coded by inter picture prediction coding where a single picture that belongs to pictures including at least a single picture in the backward direction is referred to for each block, and
the instruction indicates that coding is performed using a combination of the forward prediction P pictures and the I picture.

12. The coding method according to claim 9,
wherein the identification signal is the data indicating delay time between time when a picture has decoded and time when the decoded picture has displayed and indicates that the reordering of pictures is unnecessary in the case where the delay time is set at “0”.

13. The coding method according to claim 9,
wherein the identification signal is data indicating a largest difference, which is caused by the reordering of pictures, between a decoding order and a display order, and indicating that the reordering of pictures is unnecessary in the case where the largest difference is set at “0”.

14. A decoding method for decoding an I picture and an inter picture prediction coding picture, the I picture being coded by intra picture prediction coding and the inter picture prediction coding picture being coded by inter picture prediction coding where a picture in a forward direction or in a backward direction in display order are referred to, comprising steps of:
receiving an identification signal indicating that a reordering of pictures is unnecessary and sequence data that is coded in display order;
decoding the sequence data in receiving order according to the identification signal; and
outputting the decoded pictures in decoding order so as to be displayed.

15. A decoding method for decoding an I picture and an inter picture prediction coding picture, the I picture being coded by intra picture prediction coding and the inter picture prediction coding picture being coded by inter picture prediction coding where a picture in a forward direction or in a backward direction in display order are referred to, comprising steps of:
receiving an identification signal indicating whether or not a reordering of pictures is necessary and sequence data;
judging whether the identification signal indicates that the reordering of pictures is necessary or the reordering of pictures is unnecessary; and
outputting the signals of the pictures by decoding the signals in receiving order in the case where it is judged that the identification signal indicates that the reordering of pictures is unnecessary, and outputting the pictures by decoding the received signals of the pictures and reordering the pictures in display order in the case where it is judged that the identification signal indicates that the reordering of pictures is necessary.

16. The decoding method according to claim 14,
wherein the identification signal is the data indicating delay time between time when a picture has decoded and time when the decoded picture has displayed and indicates that the reordering of pictures is unnecessary in the case where the delay time is set at “0”.

17. The decoding method according to claim 14,
wherein the identification signal is the data indicating a largest difference, caused by the reordering of the pictures, between a decoding order and a display order and also indicating that the reordering of pictures is unnecessary in the case where the largest difference is set at “0”.

18. A program for causing a computer to execute a coding method according claim 9.

19. The decoding method according to claim 15,
wherein the identification signal is the data indicating delay time between time when a picture has decoded and time when the decoded picture has displayed and indicates that the reordering of pictures is unnecessary in the case where the delay time is set at “0”.

20. The decoding method according to claim 15,
wherein the identification signal is the data indicating a largest difference, caused by the reordering of the pictures, between a decoding order and a display order and also indicating that the reordering of pictures is unnecessary in the case where the largest difference is set at “0”.

21. A program for causing a computer to execute a decoding method according to claim 14.

22. A program for causing a computer to execute a decoding method according to claim 15.
